(19) United States
(12) Patent Application Publication
(10) Pub. No.: US 2025/0031140 A1
(43) Pub. Date: Jan. 23, 2025

(54) METHOD AND APPARATUS FOR PERFORMING RRC CONNECTION RESUMPTION IN MOBILE WIRELESS COMMUNICATION SYSTEM

(71) Applicants: Soenghun KIM, Gyeonggi-do (KR); BLACKPIN INC., Seoul (KR)

(72) Inventor: Soenghun KIM, Gyeonggi-do (KR)

(21) Appl. No.: 18/747,581

(22) Filed: Jun. 19, 2024

(30) Foreign Application Priority Data
Jul. 21, 2023 (KR) 1020230095378

(51) Int. Cl. H04W 48/20; H04W 76/27

(52) U.S. Cl. CPC H04W 48/20; H04W 76/27

(57) ABSTRACT

A method and apparatus to address the problems of supporting uplink positioning in mobile network is provided. The method of the terminal includes receiving a first RRC message including configuration information for TYPE2-I-SRS and a cell list for a first area and a cell list for a second area, performing TYPE2-I-SRS transmission based on the configuration information for TYPE2-I-SRS in a first cell if the first cell belongs to the second area, initiating RRC connection resume procedure in a second cell if the second cell does not belong to the second area, setting resumeCause to a second value if the second cell does not belong to the first area and to a first value if the second cell belong to the first area, transmitting RRCResumeRequest in the second cell, receiving a second RRC message in the second cell, and performing TYPE2-I-SRS transmission in a third cell based on the second RRC message.

### CROSS-REFERENCE TO RELATED APPLICATION

This application claims priority to and the benefit of Korean Patent Application No. 10-2023-0095378, filed on Jul. 21, 2023, the disclosure of which is hereby incorporated herein by reference in its entirety.

### BACKGROUND

### Technical Field

The present disclosure relates to positioning sounding reference signal transmission in wireless mobile communication system.

### Related Art

To meet the increasing demand for wireless data traffic since the commercialization of 4th generation (4G) communication systems, the 5th generation (5G) system is being developed. For the sake of high, 5G system introduced millimeter wave (mmW) frequency bands (e.g. 60 GHz bands). In order to increase the propagation distance by mitigating propagation loss in the 5G communication system, various techniques are introduced such as beamforming, massive multiple-input multiple output (MIMO), full dimensional MIMO (FD-MIMO), array antenna, analog beamforming, and large-scale antenna. In addition, base station is divided into a central unit and plurality of distribute units for better scalability. To facilitate introduction of various services, 5G communication system targets supporting higher data rate and smaller latency.

The importance of terminal positioning in new services such as the above-mentioned machine communication is increasing. Positioning can be estimated in consideration of the measurement result of the base station measuring the uplink reference signal transmitted by the terminal or the measurement result of the terminal measuring the downlink reference signal transmitted by the base station.

### SUMMARY

Aspects of the present disclosure are to address the problems of supporting uplink positioning in mobile network. The method of the terminal includes receiving a first RRC message including configuration information for TYPE2-I-SRS and a cell list for a first area and a cell list for a second area, performing TYPE2-I-SRS transmission based on the configuration information for TYPE2-I-SRS in a first cell if the first cell belongs to the second area, initiating RRC connection resume procedure in a second cell if the second cell does not belong to the second area, setting resumeCause to a second value if the second cell does not belong to the first area and to a first value if the second cell belong to the first area, transmitting RRCResumeRequest in the second cell, receiving a second RRC message in the second cell, and performing TYPE2-I-SRS transmission in a third cell based on the second RRC message.

### BRIEF DESCRIPTION OF THE DRAWINGS

FIG. 1A is a diagram illustrating the architecture of an 5G system and a NG-RAN to which the disclosure may be applied.

FIG. 1B is a diagram illustrating a wireless protocol architecture in an 5G system to which the disclosure may be applied.

FIG. 1C is a diagram illustrating the architecture of positioning system.

FIG. 2 is a diagram illustrating operations of a terminal and a base station according to an embodiment of the present invention.

FIG. 3 is a flow diagram illustrating an operation of a terminal.

FIG. 4A is a block diagram illustrating the internal structure of a UE to which the disclosure is applied.

FIG. 4B is a block diagram illustrating the configuration of a base station according to the disclosure.

### DETAILED DESCRIPTION

Hereinafter, embodiments of the present invention will be described in detail with reference to the accompanying drawings. In addition, in the description of the present invention, if it is determined that a detailed description of a related known function or configuration may unnecessarily obscure the gist of the present invention, the detailed description thereof will be omitted. In addition, the terms to be described later are terms defined in consideration of functions in the present invention, which may vary according to intentions or customs of users and operators. Therefore, the definition should be made based on the content throughout this specification.

The terms used, in the following description, for indicating access nodes, network entities, messages, interfaces between network entities, and diverse identity information is provided for convenience of explanation. Accordingly, the terms used in the following description are not limited to specific meanings but may be replaced by other terms equivalent in technical meanings.

In the following descriptions, the terms and definitions given in the latest 3GPP standards are used for convenience of explanation. However, the present disclosure is not limited by use of these terms and definitions and other arbitrary terms and definitions may be employed instead.

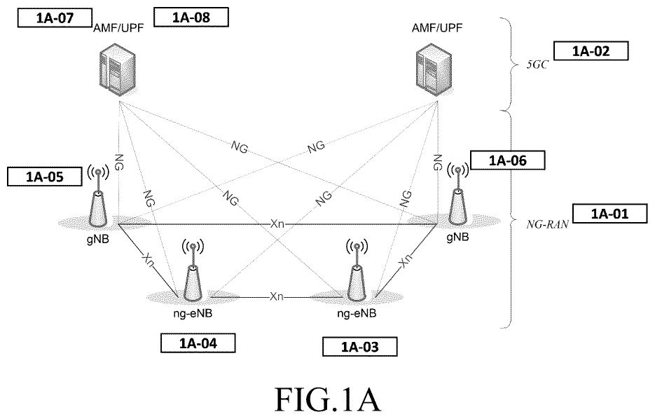

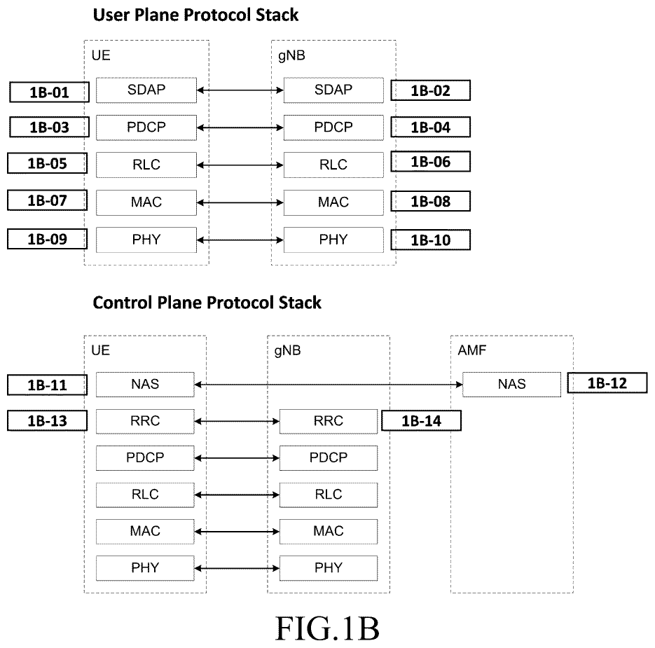

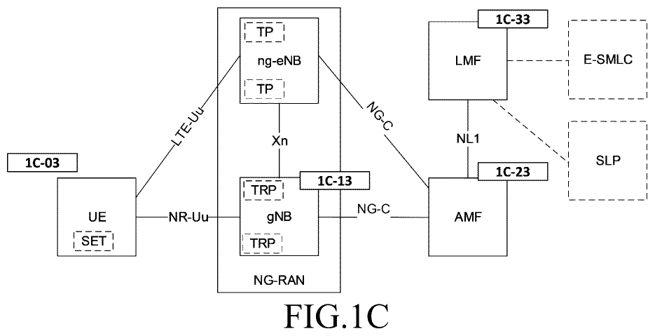

FIG. 1A is a diagram illustrating the architecture of an 5G system and a NG-RAN to which the disclosure may be applied.

5G system consists of NG-RAN 1A-01 and 5GC 1A-02. An NG-RAN node is either:
a gNB, providing NR user plane and control plane protocol terminations towards the UE; or
an ng-eNB, providing E-UTRA user plane and control plane protocol terminations towards the UE.

The gNBs 1A-05 or 1A-06 and ng-eNBs 1A-03 or 1A-04 are interconnected with each other by means of the Xn interface. The gNBs and ng-eNBs are also connected by means of the NG interfaces to the 5GC, more specifically to the AMF (Access and Mobility Management Function) and to the UPF (User Plane Function). AMF 1A-07 and UPF 1A-08 may be realized as a physical node or as separate physical nodes.

A gNB 1A-05 or 1A-06 or an ng-eNBs 1A-03 or 1A-04 hosts the functions listed below.

Functions for Radio Resource Management such as Radio Bearer Control, Radio Admission Control, Connection Mobility Control, Dynamic allocation of resources to UEs in uplink, downlink and sidelink (scheduling); and

IP and Ethernet header compression, uplink data decompression and encryption of user data stream; and

Selection of an AMF at UE attachment when no routing to an MME can be determined from the information provided by the UE; and

Routing of User Plane data towards UPF; and

Scheduling and transmission of paging messages; and

Scheduling and transmission of broadcast information (originated from the AMF or O&M); and

Measurement and measurement reporting configuration for mobility and scheduling; and

Session Management; and

QoS Flow management and mapping to data radio bearers; and

Support of UEs in RRC_INACTIVE state; and

Radio access network sharing; and

Tight interworking between NR and E-UTRA; and

Support of Network Slicing.

The AMF 1A-07 hosts the functions such as NAS signaling, NAS signaling security, AS security control, SMF selection, Authentication, Mobility management and positioning management.

The UPF 1A-08 hosts the functions such as packet routing and forwarding, transport level packet marking in the uplink, QoS handling and the downlink, mobility anchoring for mobility etc.

FIG. 1B is a diagram illustrating a wireless protocol architecture in an 5G system to which the disclosure may be applied.

User plane protocol stack consists of SDAP 1B-01 or 1B-02, PDCP 1B-03 or 1B-04, RLC 1B-05 or 1B-06, MAC 1B-07 or 1B-08 and PHY 1B-09 or 1B-10. Control plane protocol stack consists of NAS 1B-11 or 1B-12, RRC 1B-13 or 1B-14, PDCP, RLC, MAC and PHY.

Each protocol sublayer performs functions related to the operations listed below.

NAS: authentication, mobility management, security control etc

RRC: System Information, Paging, Establishment, maintenance and release of an RRC connection, Security functions, Establishment, configuration, maintenance and release of Signalling Radio Bearers (SRBs) and Data Radio Bearers (DRBs), Mobility, QoS management, Detection of and recovery from radio link failure, NAS message transfer etc.

SDAP: Mapping between a QoS flow and a data radio bearer, Marking QoS flow ID (QFI) in both DL and UL packets.

PDCP: Transfer of data, Header compression and decompression, Ciphering and deciphering, Integrity protection and integrity verification, Duplication, Reordering and in-order delivery, Out-of-order delivery etc.

RLC: Transfer of upper layer PDUs, Error Correction through ARQ, Segmentation and re-segmentation of RLC SDUs, Reassembly of SDU, RLC re-establishment etc.

MAC: Mapping between logical channels and transport channels Multiplexing/demultiplexing of MAC SDUs belonging to one or different logical channels into/from transport blocks (TB) delivered to/from the physical layer on transport channels, Scheduling information reporting, Priority handling between UEs, Priority handling between logical channels of one UE etc.

PHY: Channel coding, Physical-layer hybrid-ARQ processing, Rate matching, Scrambling, Modulation, Layer mapping, Downlink Control Information, Uplink Control Information etc.

FIG. 1C is a diagram illustrating the architecture of positioning system.

FIG. 1C is a diagram illustrating a structure of a positioning system according to an embodiment of the present disclosure.

The terminal 1C-03 is connected to the LMF 1C-33 through the gNB 1C-13 and the AMF 1C-23. Hereinafter, gNB is also referred to as a base station, AMF as an access mobility function, and LMF as a location management function.

The base station provides the TRP function. AMF stores the capability of the terminal related to location confirmation and relays the signaling between the location management function and the terminal. AMF may be connected to several base stations. One AMF can be connected to several LMFs. The AMF may initially select the LMF for any terminal. The AMF may select another LMF when the terminal moves to a new cell.

The LMF manages the support of different location services for target UEs, including positioning of UEs and delivery of assistance data to UEs.

The LMF may interact with a target UE in order to deliver assistance data if requested for a particular location service, or to obtain a location estimate if that was requested.

For positioning of a target UE, the LMF decides on the position methods to be used

The positioning methods may yield a location estimate for UE-based position methods and/or positioning measurements for UE-assisted and network-based position methods. The LMF may combine all the received results and determine a single location estimate for the target UE (hybrid positioning). Additional information like accuracy of the location estimate and velocity may also be determined.

An IE in a field may contain one or more child fields and child IEs. In that sense, an IE can be regarded as a container.

A container contains one or more child fields and child containers. Presence of a (child/downstream) fields under a (parent/upstream) container is determined by the presence of the (parent/upstream) container. A (child/downstream) field associated with a (parent/upstream) container (i.e. a field under a container) is absent if the associated (parent/upstream) container is absent. A (child/downstream) field associated with a container may be present if the associated (parent/upstream) container is present. Presence of a container affects presence of fields under the container.

Presence of a field under a container A is not affected by presence of container B unless the container B is contained in the container A or vice versa.

Container A and container B do not affect each other in terms of presence unless the container B is contained in the container A or vice versa. Presence of a container does not affect the presence of the other container in the same level.

In this invention, XXX_XXX and XxxXxx denotes an IE. xxx_xxx and xxxXxx denotes a field. xxx_XXX denotes a variable. XXX_xxx denotes a value indicated in xxx_xxx field. X denotes an upper character. x denotes an lower character.

In this invention, UE and Terminal and wireless device are used interchangeably. GNB and base station are used interchangeably.

L3-XXX-XXX means Layer 3 control message of XXX-XXX. L2-XXX-XXX means Layer 2 control message (or MAC CE) of XXX-XXX. L1-DCI-N-M means Layer 1 DCI format N_M.

In this invention, a method to reduce network energy consumption is introduced. GNB can configure cell specific active time. By turning off the transmitter during cell specific non active time, GNB energy consumption can be reduced. By turning off the receiver during cell specific non active time, GNB energy consumption can be reduced.

Continuous uplink positioning may be beneficial for some service scenarios such as industrial IoT. For continuous uplink positioning, UE in RRC_INACTIVE state needs to keep positioning SRS transmission even when UE moves between cells.

In this invention, UE may be configured with following SRS which may be valid over various geographical areas and/or frequency domain locations.

RRCRelease and RRCReconfiguration and RRCSetup and RRCReconfigurationComplete are RRC messages.

C-SRS is:

>1: SRS used in RRC_CONNECTED; and

>1: the SRS configuration information of the C-SRS may be provided in a RRCReconfiguration or in a RRCSetup received in a specific cell.

>1: SRS valid in a specific BWP of a specific uplink carrier of the specific cell.

>>2: the specific BWP is the BWP of which configuration information include the SRS configuration information; the specific BWP is the BWP associated with the SRS configuration;

>>2: the specific uplink carrier is the uplink carrier of which configuration information include the BWP information associated with the SRS configuration; the specific uplink carrier is the uplink carrier of which configuration information includes the SRS configuration information;

>>2: the specific cell is the cell of which configuration information includes the uplink carrier configuration information associated with the SRS configuration; the specific cell is the cell of which configuration information includes the SRS configuration information.

TYPE1-I-SRS is:

1>: SRS that is used in RRC_INACTIVE state in a single cell; and

>1: the SRS configuration information of the TYPE1-I-SRS is provided in a RRCRelease received in a specific cell.

1>: SRS that is valid in a specific BWP of a specific uplink carrier of the specific cell.

>>2: the configuration information of the specific BWP is provided in the RRCRelease received in the specific cell;

>>2: the specific uplink carrier is an uplink carrier of the specific cell; the configuration information of the specific carrier is in SIBI of the cell where RRCRelease is received;

>>2: the specific cell is the cell where RRCRelease is received;

TYPE2-I-SRS is:

>1: SRS that is used in RRC_INACTIVE state in two or more cells; and

>1: the SRS configuration information of the TYPE2-I-SRS is provided in a RRCRelease received in a specific cell.

1>: SRS that is valid in a specific BWP of a specific uplink carrier of cells of SRS-Area;

>>2: the configuration information of the specific BWP is provided in the RRCRelease received in the specific cell;

>>>3: the configuration information of the specific BWP is valid in and commonly applied to the cells of SRS-Area

>>2: the specific uplink carrier is an uplink carrier of the cells of SRS-Area; the configuration information of the specific carrier is provided in SIBI of the cell where RRCRelease is received;

>>2: the SRS-Area is indicated in the RRCRelease.

Based on the requirements at a given circumstances, GNB may configure UE to perform SRS transmission:

>1: in RRC_CONNECTED in a single cell; or

>1: in RRC_INACTIVE in a single cell; or

>1: in RRC_INACTIVE over two or more cells.

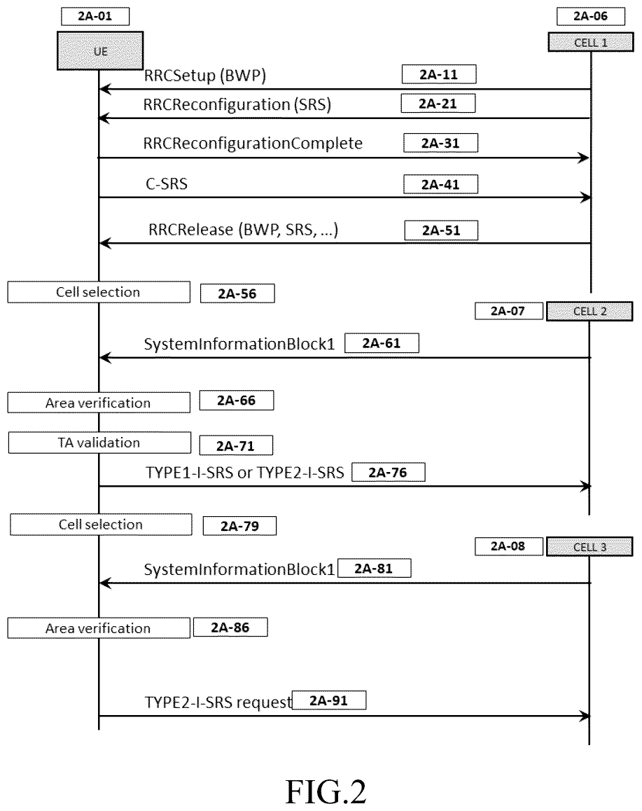

FIG. 2 illustrates the operation of UE and GNB for SRS transmission.

At 2A-11, UE may receive from a base station a RRCSetup in a first cell.

The RRCSetup is used to establish RRC connection (e.g. SRB1) between UE and the base station.

The RRCSetup includes various configuration information such as uplink BWP configuration information (e.g. BWP-Uplink) and downlink BWP configuration information (e.g. BWP-Dwonlink).

UE can be configured with one or more uplink BWPs. BWP-Uplink for an uplink BWP may include following fields:

>1: locationAndBandwidth field indicates frequency domain location and bandwidth of this bandwidth part. The value of the field shall be interpreted as resource indicator value (RIV). The first PRB may be a PRB determined by subcarrierSpacing of this BWP and offsetToCarrier (in ServingCellConfigCommonSIB in SIB1).

>1: cyclicPrefix field indicates whether to use the extended cyclic prefix for this bandwidth part. If not set, the UE uses the normal cyclic prefix.

>1: subcarrierSpacing field indicates subcarrier spacing to be used in this BWP for all channels and reference signals unless explicitly configured elsewhere.

After establishing SRB1, UE may report its capability to the base station by transmitting UECapabilityInformation RRC message.

Based on the reported capability and cell load and required traffic requirements, the base station may determine the various configurations for the UE. If SRS is deemed useful, the base station may decide to configure C-SRS for the UE (if not configured yet).

At 2A-21, the base station may transmitto the UE a RRCReconfiguration in the first cell.

The RRCReconfiguration may be used to modify the RRC connection. The message may convey information for measurement configuration, mobility control, radio resource configuration (including RBs, MAC main configuration and physical channel configuration) and AS security configuration. The message may include C-SRS configuration information (e.g., one or more instances of SRS-Config) for the UE.

A SRS-Config is associated with an uplink BWP.

A SRS-Config may include configuration information for one or more SRS resource sets (e.g., one or more SRS-ResourceSet in srs-ResourceSetToAddModList) and/or configuration information for one or more SRS resources (e.g., one or more SRS-Resource in srs-ResourceToAddModList) and/or configuration information for one or more positioning SRS resource set (e.g., one or more SRS-PosResourceSet in srs-PosResourceSetToAddModList) and/or configuration information for one or more positioning SRS resources (e.g., one or more SRS-PosResource in srs-PosResourceToAddModList).

A SRS-PosResourceSet IE may include information for positioning SRS resource set. A SRS-PosResourceSet IE may be for either C-SRS or TYPE1-I-SRS or TYPE2-I-SRS depending on in which parent IE and in which RRC message the SRS-PosResourceSet IE may be included.

A SRS-PosResourceSet IE may include following fields:

>1: srs-PosResourceSetId field indicates the identifier of this positioning SRS resource set (SRS-PosResourceSet).

>1: srs-PosResourceIdList field indicates the identifiers of SRS-PosResources that comprises the SRS-PosResourceSet.

>1: alpha field indicates alpha value for SRS power control. The value indicated by this field may be applied to all (one or more) SRS-PosResources that belong to the SRS-PosResourceSet.

>1: p0 field indicates P0 value for SRS power control. The value indicated by this field may be applied to all (one or more) SRS-PosResources that belong to the SRS-PosResourceSet.

>1: resourceType field indicates time domain behavior of SRS resource configuration. Either aperiodic or periodic or semi-persistent is indicated.

>1: pathlossReferenceRS-Pos field indicates a reference signal (e.g., a SS block or a DL-PRS config) to be used for SRS path loss estimation; This field includes either ssb-IndexServing field or ssb-Ncell field or dl-PRS field;

>>2: ssb-IndexServing indicates SSB index belonging to a serving cell where the SRS may be configured.

>>2: ssb-NCell indicates a SSB configuration from neighboring cell (e.g. SSB-InfoNcell).

>>2: dl-PRS indicates a PRS configuration (e.g., DL-PRS-Info).

A SRS-PosResource IE may include the configuration information for positioning SRS. A SRS-PosResource IE is for either C-SRS or TYPE1-I-SRS or TYPE2-I-SRS depending on in which parent IE/container and in which RRC message the SRS-PosResource IE is included.

A SRS-PosResource IE may include following fields:

>1: srs-PosResourceId field indicates the identifier of the positioning SRS resource;

>1: resourceType field indicates periodicity and offset for semi-persistent and periodic SRS resource, or slot offset for aperiodic SRS resource for positioning;

>1: resourceMapping field indicates OFDM symbol location of the SRS resource within a slot including nrofSymbols (number of OFDM symbols), startPosition (value 0 refers to the last symbol, value 1 refers to the second last symbol, and so on) and repetitionFactor;

>1: spatialRelationInfoPos field indicates configuration of the spatial relation between a reference RS and the target SRS. Reference RS can be SSB/CSI-RS/SRS/DL-PRS.

>1: freqHopping field indicates:

>>2: SRS bandwidth of the positioning SRS resource;

>>2: hopping bandwidth of the positioning SRS resource;

>1: freqDomainShift field indicates configurable shift from the frequency domain position.

freqDomainPosition field indicates the frequency domain position of SRS resource by indicating an integer between 0 and 67.

For positioning SRS resource, freqDomainPosition is not explicitly signaled. A fixed value of 0 is applied to positioning SRS resource.

Positioning SRS transmission may be performed with frequency-hopping within an uplink bandwidth part. UE determines the hopping pattern based on the position and the size of the uplink bandwidth part.

At 2A-31, UE may transmit to the base station a RRCReconfigurationComplete to confirm successful completion of RRC connection reconfiguration.

At 2A-41, UE may perform SRS transmission in RRC connected mode (C-SRS) based on SRS configuration and BWP configuration and cell configuration.

For C-SRS transmission in the cell 1, UE may:

>1: determine the frequency domain resource for C-SRS transmission based on:

>>2: locationAndBandwidth field, for the current active BWP, received in RRCSetup or in RRCReconfiguration RRC mmessage; and

>>2: offsetToCarrier field indicated in ServingCellConfigCommon in RRCSetup or in ServingCellConfigCommonSIB in SIB 1 of the cell 1;

>>2: freqHopping field and freqDomainShift field in SRS-PosResource in RRCReconfiugration RRC message;

>1: determine the time domain resource for C-SRS transmission based on resourceMapping field received in RRCReconfiguration.

UE may stop C-SRS transmission upon BWP switch or upon C-SRS release instructed by another RRCReconfiguration.

RRCSetup and RRCReconfiguration and SIB 1 above are received in the cell1.

At some point of time, GNB may decides to change RRC state of the UE from RRC_CONNECTED to RRC_INACTIVE. If user traffic for the UE is exhausted but SRS transmission is still required for positioning purpose, putting UE in RRC_INACTIVE is better option for UE power consumption perspective.

At 2A-51, GNB may transmit to the UE a RRCRelease to instruct state transition to RRC_INACTIVE and positioning SRS transmission in RRC_INACTIVE.

For state transition to RRC_INACTIVE, GNB includes a SuspendConfig IE in the RRCRelease. SuspendConfig IE may include various fields related to RRC_INACTIVE state. More specifically, SuspendConfig IE may include following fields:

>1: ran-ExtendedPagingCycle indicates the extended DRX (eDRX) cycle for RAN-initiated paging to be applied by the UE. Value rf256 corresponds to 256 radio frames, value rf512 corresponds to 512 radio frames and so on. Value of the field indicates an eDRX cycle which may be shorter or equal to the IDLE mode eDRX cycle configured for the UE;

>1: ran-NotificationAreaInfo indicates RAN-based Notification Area (RNA) where UE can move between RNA cells without reporting location change to the base station; This field includes one or more PLMN-RAN-AreaCell IEs.

>>2: A PLMN-RAN-AreaCell IE may include a PLMN-Identity and one or more CellIdentity.

>>>3: CellIdentity is 36 bit long.

>>>3: CellIdentity uniquely identify a cell within a PLMN.

>>>3: 22˜32 leftmost bits of the CellIdentity IE correspond to GNB ID

>1: ran-PagingCycle indicates the UE specific cycle for RAN-initiated paging.

>1: t380 may be the timer that triggers the periodic RNAU procedure in UE. Value min5 corresponds to 5 minutes, value min 10 corresponds to 10 minutes and so on.

>1: srs-PosRRC-Inactive may include parameters for SRS transmission on a single cell in RRC_INACTIVE (e.g., TYPE1-I-SRS).

>1: srs_positioning_inactive_multi-cell include parameters for SRS transmission on multiple cells in RRC_INACTIVE (e.g., TYPE2-I-SRS)

srs-PosRRC-Inactive includes following fields:

>1: bwp-NUL field includes BWP configuration for SRS for Positioning during the RRC_INACTIVE state (TYPE1-I-SRS) in Normal Uplink Carrier of a specific cell.

>>2: If the field is absent and srs-PosConfigNUL field is present,

>>>3: UE is configured with a SRS for Positioning associated with the initial UL BWP of the normal uplink carrier of the specific cell; and

>>>3: UE may transmit, during the RRC_INACTIVE state, inside the initial UL BWP of the normal uplink carrier with the same CP and SCS as configured for initial UL BWP of the normal uplink of the specific cell.

>1: bwp-SUL field includes BWP configuration for SRS for Positioning during the RRC_INACTIVE state in Supplementary Uplink Carrier of a specific cell.

>>2: If the field is absent and srs-PosConfigSUL field is present,

>>>3: UE may be configured with a SRS for Positioning associated with the initial UL BWP of the supplementary uplink carrier of the specific cell; and

>>>3: UE may transmit, during the RRC_INACTIVE state, inside the initial UL BWP of the supplementary uplink carrier with the same CP and SCS as configured for initial UL BWP of the supplementary uplink carrier of the specific serving cell.

>1: srs-PosConfigNUL field includes positioning SRS in RRC_INACTIVE state (TYPE1-I-SRS) in Normal Uplink Carrier of the specific serving cell. This field contains a SRS-PosConfig IE.

>1: srs-PosConfigSUL field includes SRS for Positioning configuration in RRC_INACTIVE state (TYPE1-I-SRS) in Supplementary Uplink Carrier. This field contains a SRS-PosConfig IE.

>1: inactivePosSRS-RSRP-ChangeThreshold field indicates RSRP threshold for the increase/decrease of RSRP for time alignment validation.

>1: inactivePosSRS-TimeAlignmentTimer field indicates TAT value for SRS for positioning transmission (TYPE1-I-SRS) during RRC_INACTIVE state.

SRS-PosConfig IE may include parameters for positioning SRS transmission during RRC_INACTIVE state. The IE may include following fields:

>1: srs-PosResourceSetToReleaseList field includes one or more SRS-PosResourceSetId. UE may release the indicated SRS-PosResrouceSet.

>1: srs-PosResourceSetToAddModList includes one or more SRS-PosResourceSet. UE may perform SRS transmission in the indicated SRS-PosResourceSet.

>1: srs-PosResourceToReleaseList field includes one or more SRS-PosResourceId. UE may release the indicated SRS-PosResource and may not transmit SRS on the indicated resource.

>1: srs-PosResourceToAddModList field indlcudes one or more SRS-PosResource. UE may perform SRS transmission in the indicated SRS-PosResource.

srs_positioning_inactive_multi_cell

srs-PosRRC-Inactive may include following fields:

>1: bwp_NUL_multi_cell field includes BWP configuration for SRS for Positioning during the RRC_INACTIVE state in Normal Uplink Carrier in two or more cells (TYEP2-I-SRS). bwp_NUL_multi_cell may include parameters applied to two or more cells.

>>2: If the field is absent and srs_PosConfigNUL_multi_cell field is present,

>>>3: UE may be configured with a SRS for Positioning associated with the initial UL BWP of the normal uplink carrier of a specific cell for two or more cells; and

>>>3: UE may transmit, in two or more cells during the RRC_INACTIVE state, inside the frequency domain portion equivalent to the initial UL BWP of the normal uplink carrier of the specific cell with the same CP and SCS as configured for initial UL BWP of the normal uplink of the specific cell. The specific cell may be the cell where RRCRelease (srs_positioning_inactive_multi_cell) may be received.

>1: bwp_SUL_multi-cell field includes BWP configuration for SRS for Positioning during the RRC_INACTIVE state in Supplementary Uplink Carrier of two or more cells (TYEP2-I-SRS). bwp_SUL_multi-cell includes parameters applied to two or more cells.

>>2: If this field is absent and srs_PosConfigSUL_multi_cell field is present,

>>>3: UE is configured with a SRS for Positioning associated with the initial UL BWP of the supplementary uplink carrier of a specific cell for two or more cells; and

>>>3: UE may transmit, in two or more cells during the RRC_INACTIVE state, inside the frequency domain portion equivalent to the initial UL BWP of the supplementary uplink carrier of the specific cell with the same CP and SCS as configured for initial UL BWP of the supplementary uplink of the specific cell. The specific cell may be the cell where RRCRelease (srs_positioning_inactive_multi_cell) is received.

>1: srs_PosConfigNUL_multi_cell field includes SRS for Positioning configuration in RRC_INACTIVE state in Normal Uplink Carrier for two or more cells (TYPE2-I-SRS). This field contains a SRS-PosConfig IE.

>1: srs_PosConfigSUL_multi_cell field includes SRS for Positioning configuration in RRC_INACTIVE state in Supplementary Uplink Carrier for two or more cells (TYPE2-I-SRS). This field contains a SRS-PosConfig IE.

>1: inactivePosSRS-RSRP-ChangeThreshold_multi_cell field indicates RSRP threshold for the increase/decrease of RSRP for time alignment validation for TYPE2-I-SRS. This field includes a parameter applicable to two or more cells.

>1: inactivePosSRS_TimeAlignmentTimer_multi_cell field indicates Time Alignment Timer value for SRS for positioning transmission during RRC_INACTIVE state in two or more cells. This field includes a parameter applicable to two or more cells.

>1: srs_PosConfig_cell_list field indicates two or more cells where TYPE2-I-SRS can be transmitted. This field includes a SRS_AreaCell IE or an same_as_RNA indicator.

>>2: A SRS-AreaCell IE includes either two or more CellIdentity or two or more PhysicalCellId.

>>>3: unlike RNA which covers relatively wide area, SRS-Area covers narrow area consisting of one or more adjacent cells. Because of that, SRS-AreaCell IE does not include PLMN identity.

>>>3: if CellIdentity is included, UE determines that a cell which broadcast the same CellIdentity in the SIBI belongs to SRS-Area;

>>>3: if PhysicalCellId is included, UE determines that a cell with the same PhysicalCellId in a specific frequency layer belongs to SRS-Area;

>>>4: the specific frequency layer is the frequency layer where the specific cell belongs to (e.g., the frequency layer with same ARFCN as specific cells' ARFCN).

>>>3: CellIdentity indicates (corresponds to) a base station and a cell;

>>>3: PhysicalCellId indicates (corresponds to) a cell;

>>2: same_as_RNA indicator indicates whether SRS-Area (where TYPE2-I-SRS may be valid) is same as RNA.

Based on the information included in RRCRelease, UE may perform RRC state transition to RRC_INACTIVE and cell selection 2A-56.

Cell selection and cell reselection are the process by which a UE selects a cell to camp on in order to receive service from the network.

The difference is that:

>1: in cell selection, UE try to find a suitable cell by scanning all RF channels in the NR bands according to its capabilities or by stored information on frequencies;

>1: in cell reselection, UE try to find a suitable cell based on the system information received in the currently camped cell.

UE may select a cell that is different from the cell where RRCRelease is received (e.g., UE selects the cell 2 2A-07 from the cell 1 2A-06).

At 2A-61, UE may receive a system information block 1 (SIB1) in the cell2.

SIB1 contains information relevant when evaluating if a UE is allowed to access a cell and defines the scheduling of other system information. It also contains radio resource configuration information that is common for all UEs and barring information applied to the unified access control.

A cell can be assigned with a one or more cellIdentity. In this case, SIB1 includes one or more cellIdentity. SIB1 also includes a ServingCellConfigCommonSIB.

The ServingCellConfigCommonSIB is used to configure cell specific parameters of a UE's serving cell in SIB1.

ServingCellConfigCommonSIB may include following fields:

>1: downlinkConfigCommon field includes DownlinkConfigCommonSIB IE

>1: uplinkConfigCommon field includes UplinkConfigCommonSIB IE for normal uplink carrier of the cell

>1: supplementaryUplink field includes UplinkConfigCommonSIB IE for supplementary uplink carrier of the cell

>1: n-TimingAdvanceOffset field indicates the N_TA-Offset to be applied for all uplink transmissions on this serving cell. If the field is absent, the UE applies the value defined for the duplex mode and frequency range of this serving cell.

UplinkConfigCommonSIB IE may include following fields:

>1: frequencyInfoUL field includes FrequencyInfoUL-SIB IE.

>1: initialUplinkBWP field includes BWP-UplinkCommon IE for the initial uplink BWP of the cell.

>1: timeAlignmentTimerCommon field includes TimeAlignmentTimer IE for time alignment timer to applied during initial random access procedure.

FrequencyInfoUL-SIB IE may include following fields:

>1: absoluteFrequencyPointA field includes ARFCN-ValueNR IE;

>>2: absoluteFrequencyPointA indicates Absolute frequency of the reference resource block (Common RB 0). Its lowest subcarrier may be also known as Point A.

>1: scs-SpecificCarrierList field includes one or more SCS-SpecificCarrier IEs;

>>2: scs-SpecificCarrierList field indicates a set of carriers for different subcarrier spacings (numerologies).

>>2: each of SCS-SpecificCarrier provides parameters determining the location and width of the actual carrier or the carrier bandwidth. A SCS-SpecificCarrier may include following fields:

>>>3: offsetToCarrier field indicates an integer between 0 and 2199. This field indicates offset in frequency domain between Point A (lowest subcarrier of common RB 0) and the lowest usable subcarrier on this carrier in number of PRBs (using the subcarrierSpacing defined for this carrier).

>>2 if UE is performing TYPE2-I-SRS transmission in cell2 (e.g. cell belongs to SRS-Area but not the cell where RRCRelease is received), UE may apply, to TYPE2-I-SRS transmission in cell2, the value contained in the field received in celll (e.g. cell where RRCRelease is received);

>>2 if UE is performing TYPE1-I-SRS transmission in cell1, UE may apply, to TYPE1-I-SRS transmission in cell 1, the value contained in the field received in cell1 (e.g. cell where RRCRelease is received);

>>>3: subcarrierSpacing indicates subcarrier spacing of this carrier. It may be used to convert the offsetToCarrier into an actual frequency.

>>>>4: if UE is performing TYPE2-I-SRS transmission in cell2 (e.g. cell belongs to SRS-Area but not the cell where RRCRelease is received), UE may apply, to TYPE2-I-SRS transmission in cell2, the value contained in the field received in celll (e.g. cell where RRCRelease is received);

>>>>4: if UE is performing TYPE1-I-SRS transmission in cell1, UE may apply, to TYPE1-I-SRS transmission in cell 1, the value contained in the field received in cell1 (e.g. cell where RRCRelease is received);

>>>3: carrierBandwidth indicates width of this carrier in number of PRBs (using the subcarrierSpacing defined for this carrier);

>>>>4: if UE is performing TYPE2-I-SRS transmission in cell2 (e.g. cell belongs to SRS-Area but not the cell where RRCRelease is received), UE may apply, to TYPE2-I-SRS transmission in cell2, the value contained in the field received in celll (e.g. cell where RRCRelease is received);

>>>>4: if UE is performing TYPE1-I-SRS transmission in cell1, UE may apply, to TYPE1-I-SRS transmission in cell 1, the value contained in the field received in cell1 (e.g. cell where RRCRelease is received);

>1: frequencyShift7p5khz field indicates whether the NR UL transmission with a 7.5 kHz shift to the LTE raster may be enabled. If the field is absent, the frequency shift may be disabled.

>>2 if UE is performing TYPE2-I-SRS transmission in cell2 (e.g. cell belongs to SRS-Area but not the cell where RRCRelease is received), UE may apply, to TYPE2-I-SRS transmission in cell2, the value contained in the field received in celll (e.g. cell where RRCRelease is received);

>>2 if UE is performing TYPE1-I-SRS transmission in cell1, UE may apply, to TYPE1-I-SRS transmission in cell 1, the value contained in the field received in celll (e.g. cell where RRCRelease is received);

>1: p-Max field includes P-Max IE.

>>2: p-Max indicates Value in dBm applicable for the cell.

>>2 if UE is performing TYPE2-I-SRS transmission in cell2 (e.g. cell belongs to SRS-Area but not the cell where RRCRelease is received), UE may apply, to TYPE2-I-SRS transmission in cell2, the value contained in the field received in celll (e.g. cell where RRCRelease is received);

>>2 if UE is performing TYPE1-I-SRS transmission in cell1, UE may apply, to TYPE1-I-SRS transmission in cell 1, the value contained in the field received in cell1 (e.g. cell where RRCRelease is received);

At 2A-66, UE may perform SRS-AREA-VERIFICATION.

If TYPE1-I-SRS is configured, UE may:

>1: determine the SRS-AREA-VERIFACTION is successful if the selected cell (e.g., the new suitable cell after cell selection) is the cell where RRCRelease is received (e.g., SRS configuration information for TYPE1-I-SRS is received);

>1: determine the SRS-AREA-VERIFACTION is unsuccessful if the selected cell (e.g., the new suitable cell after cell selection) is not the cell where RRCRelease is received (e.g., SRS configuration information for TYPE1-I-SRS is received).

If TYPE2-I-SRS may be configured, UE may:

>1: determine the SRS-AREA-VERIFACTION is successful if the selected cell (e.g., the new suitable cell after cell selection) is one of the cells indicated in srs_PosConfig_cell_list (or belongs to SRS-Area);

>1: determine the SRS-AREA-VERIFACTION is unsuccessful if the selected cell (e.g., the new suitable cell after cell selection) is not one of the cells indicated in srs_PosConfig_cell_list (does not belong to SRS-Area);

If SRS-AREA-VERIFICATION is successful, UE may proceed to TA validation procedure.

If SRS-AREA-VERIFICATION is unsuccessful, UE may:

>1: if TYPE1-I-SRS is configured (e.g., SRS-AREA-VERIFICATION for TYPE1-I-SRS is unsuccessful),

>>2: stop TYPE1-I-SRS transmission; and

>>2: release TYPE1-I-SRS resource;

>1: if TYPE2-I-SRS is configured (e.g., SRS-AREA-VERIFICATION for TYPE2-I-SRS is unsuccessful),

>>2: stop TYPE2-I-SRS transmission; and

>>2: release TYPE2-I-SRS resource; and

>>2: perform a procedure to request TYPE2-I-SRS resource.

At 2A-71, UE may perform TA validation if SRS-AREA-VERIFICATION is successful.

For TA validation, UE consider whether inactivePosSRS-TimeAlignmentTimer or inactivePosSRS_TimeAlignmentTimer_multi_cell is running and how RSRP of the camped cell (e.g., serving cell) is.

At 2A-76, UE may perform TYPE1-I-SRS transmission or TYPE2-I-SRS transmission in cell2.

UE may perform TYPE1-1-SRS transmission if following conditions are met:

>1: TYPE1-I-SRS is configured; and

>1: the cell2 is the cell where RRCRelease (or TYPE1-I-SRS resource configuration information) is received; and

>1: TA validation is successful.

UE may perform TYPE2-I-SRS transmission if following conditions are met:

>1: TYPE2-I-SRS is configured; and

>1: the cell2 is a cell indicated by SRS-Area info; and

>1: TA validation is successful.

For TYPE1-I-SRS transmission in a first cell, UE may:

>1: determine the first BWP based on a first offsetToCarrier and a first location AndBandwidth;

>>2: the first offsetToCarrier is indicated in system information received in the cell where RRCRelease is received;

>>>3: the RRCRelease is the RRC message that includes the configuration information of TYPE1-I-SRS;

>>2 the first locationAndBandwidth is indicated in the RRCRelease;

>>2: the first BWP is the BWP where SRS transmission is performed;

>>2: the first BWP is a BWP of a first cell;

>>3: the first cell is the cell where RRCRelease is received;

>1: perform SRS transmission such that frequency hopping of SRS transmission is confined within the first BWP;

>1: determines the SRS transmission power based on a first P-max and a first freqHopping;

>>2: SRS transmission power in dB level is sum of SRS specific power offset (such as alpha and p0) and pathloss and power control adjustment states and a value determined from SRS bandwidth;

>>>3 SRS bandwidth is determined from freqHopping;

>>2: SRS transmission power is upper bounded by P-max;

>>2: the first freqHopping is indicated in srs-PosRRC-Inactive in RRCRelease;

>>2: the first p-Max is indicated in the system information of the cell where the RRCRelease is received;

>1: determines T_TA of the SRS based on a first n-TimingAdvanceOffset and current N_TA;

>>2: Uplink frame number i for transmission from the UE starts T_TA = (N_TA +N_TA_offset) * T_c before the start of the corresponding downlink frame i at the UE

>>>3: the N_TA_offset is indicated by n-TimingAdvanceOffset in the system information of the cell where the RRCRelease is received;

>>>>3: N_TA may be initialized during random access procedure and updated by TA command transmitted by the base station

For TYPE1-2-SRS transmission in the first cell, UE may:

>1: determine the second BWP based on a second offsetToCarrier and a first location AndBandwidth;

>>2: the second offsetToCarrier is indicated in system information received in the second cell

>>>3: the second cell is the cell where RRCRelease is received;

>>>3: the RRCRelease includes the configuration information of TYPE2-I-SRS;

>>2 the first locationAndBandwidth is indicated in the RRCRelease;

>>2: the second BWP is the BWP where SRS transmission is performed;

>>2 the second BWP is the BWP of the first cell

>>>3: the first cell is a cell belonging to SRS-Area;

>>>3: the first cell is different from the second cell;

>1: perform SRS transmission such that frequency hopping of SRS transmission is confined within the second BWP;

>1: determines the SRS transmission power based on a second P-max and a first freqHopping;

>>2: the first freqHopping is indicated in srs_positioning_inactive_multi_cell in RRCRelease;

>>2: the second p-Max is indicated in the system information of the second cell;

>1: determines T_TA of the SRS based on a secondt n-TimingAdvanceOffset and current N_TA;

>>2: the second N_TA_offset may be indicated by n-TimingAdvanceOffset in the system information of the second cell;

At 2A-79, UE may perform cell selection toward cell3 2A-08.

At 2A-81, UE may receive a system information block 1 (SIB1) in the cell3.

At 2A-86, UE may perform SRS-AREA-VERIFICATION for cell3.

At 2A-91, UE may perform TYPE2-I-SRS-REQUEST message to the base station in cell3 if SRS-AREA-VERIFICATION for cell3 fails.

During RRC_INACTIVE, UE performs cell selection and cell reselection and I-SRS transmission as below.

>1: UE receives from a base station a RRCRelease.

>1: UE stops C-TAT and maintain N_TA.

>1: UE starts TYPE1-I-TAT or TYPE2-I-TAT.

>>2: Timer value of TYPE1-I-TAT is indicated by inactivePosSRS-TimeAlignmentTimer field in srs-PosRRC-Inactive field;

>>2: Timer value of TYPE2-I-TAT is indicated by inactivePosSRS_TimeAlignmentTimer_multi_cell field or yyy field (whichever exists) in srs_positioning_inactive_multi_cell;

>1: UE enter RRC_INACTIVE.

>1: UE performs cell selection.

>1: UE receives system information in the selected cell.

>1: UE performs TYPE1-I-SRS transmission or TYPE2-I-SRS transmission in the selected cell.

>1: UE performs cell reselection.

>1: UE stops TYPE2-I-SRS transmission.

>1: UE receives system information in the reselected cell.

>1: UE resumes TYPE2-I-SRS transmission in the reselected cell.

For TYPE1-I-SRS transmission in the selected cell after state transition, UE performs followings.

>1: UE performs TA validation.

>>2: UE consider TA is valid when the following conditions are fulfilled:

>>>3: compared to the stored downlink pathloss reference RSRP value, the current RSRP value of the downlink pathloss reference has not increased/decreased by more than inactivePosSRS-RSRP-Change Threshold; and

>>>3: the downlink pathloss reference for the stored RSRP value and the downlink pathloss reference for the current RSRP value are same; and

>>>3: TYPE1-I-TAT is running.

>>2: downlink pathloss reference for the stored RSRP is the downlink pathloss reference of the cell where RRCRelease is received.

>>2: downlink pathloss reference for the current RSRP is the downlink pathloss reference of the selected cell (or reselected cell) before the comparison is performed.

>1: UE performs TYPE1-I-SRS transmission in the selected cell when TA is valid.

>>2: UE performs TYPE1-I-SRS transmission based on the system information of the selected cell and TYPE1-I-SRS configuration information in RRCRelease received in the selected cell.

>>2: UE performs TYPE1-I-SRS transmission if the selected cell is the cell where RRCRelease is received.

For TYPE2-I-SRS transmission in the selected cell after state transition, UE performs followings. SRS-Area consists of one or more cells indicated in SRS-AreaCell IE.

>1: UE determines whether the selected cell belongs to SRS-Area (e.g. SRS-Area-VERIFICATION).

>>2: if selected cell is intra-frequency cell (e.g., ARFCN of the selected cell and ARFCN of the cell where RRCRelease is received are same); and

>>2: if PCI/CellIdentity of the selected cell is included/indicated in SRS-AreaCell IE,

>>>3: UE determine the selected cell belongs to SRS-Area.

>>2: If selected cell is inter-frequency cell (e.g., ARFCN of the selected cell and ARFCN of the cell where RRCRelease is received are different),

>>>3: UE determines the selected cell does not belong to SRS-Area.

>1: UE performs TA validation if SRS-Area-VERIFICATION is successful.

>>2: UE consider TA is valid when the following conditions are fulfilled:

>>>3: compared to the stored downlink pathloss reference RSRP value, the current RSRP value of the downlink pathloss reference has not increased/decreased by more than inactivePosSRS-RSRP-ChangeThreshold; and

>>>3: the downlink pathloss reference for the stored RSRP value and the downlink pathloss reference for the current RSRP value are same; and

>>>3: TYPE2-I-TAT is running;

>>2: UE consider TA is valid when the following conditions are fulfilled:

>>>3: the downlink pathloss reference for the stored RSRP value and the downlink pathloss reference for the current RSRP value are different; and

>>>3: TYPE2-I-TAT is running;

>>>>4: UE does not consider the difference between the stored RSRP and the current RSRP if downlink pathloss reference between them are different;

>1: UE performs TYPE2-I-SRS transmission in the selected cell when TA is valid.

>>2: UE performs TYPE2-I-SRS transmission based on the system information of the selected cell and TYPE1-I-SRS configuration information in RRCRelease message.

>> The cell where system information is received and the cell where RRCRelease message is received can be different.

For TYPE2-I-SRS transmission in the reselected cell, UE performs followings.

>1: UE stops TYPE2-I-TAT and TYPE2-I-SRS transmission when cell reselection criteria are fulfilled.

>>2: cell ranking criterion of a cell is determined based on RSRP measurement;

>>2: cell reselection criteria for a new cell is fulfilled when:

>>>3: the new cell is better than the serving cell according to the cell reselection criteria specified above (e.g. cell ranking of the new is higher than cell ranking of the serving cell) during a time interval TreselectionRAT; and

>>>3: more than 1 second has elapsed since the UE camped on the current serving cell.

>1: UE receives system information in the candidate cell (e.g. new cell).

>1: UE determines whether UE can reselect the candidate cell (e.g. whether the candidate cell is suitable cell).

>>2: a cell is a suitable cell when the following conditions are fulfilled:

>>>3: The cell is part of either the selected PLMN or the registered PLMN or PLMN of the Equivalent PLMN list (this condition is determined based on received SIB1); and

>>>3: RSRP of the cell is higher than a specific threshold; and

>>>3: RSRQ of the cell is higher than another specific threshold; and

>>>3: The cell is not barred (e.g. cellBarred field in MIB is set to notBarred);

>1: UE determines whether the reselected cell belongs to SRS-Area.

>>2: if reselected cell is intra-frequency cell (e.g., ARFCN of the reselected cell and ARFCN of the cell where RRCRelease is received are same); and

>>2: if PCI/CellIdentity of the reselected cell is included/indicated in SRS-AreaCell IE field,

>>>3: UE determine the reselected cell belongs to SRS-Area.

>>2: If reselected cell is inter-frequency cell (e.g., ARFCN of the reselected cell and ARFCN of the cell where RRCRelease is received are different),

>>>3: UE determines the reselected cell does not belong to SRS-Area.

>1: UE updates the N_TA based on the time difference between a downlink frame of the old serving cell and the downlink frame of the reselected cell (e.g. OTDOA on PSS/SSS between the old cell and the new cell);

>>2: UE update the N_TA by the amount of the downlink time difference between the old serving cell and the new suitable cell;

>1: UE updates stored RSRP of downlink pathloss reference with the current RSRP of downlink pathloss reference of the reselected cell (e.g. new suitable cell).

>1: UE restarts TYPE2-I-TAT.

>1: UE performs TA validation if SRS-Area-VERIFICATION is successful.

>>2: UE consider TA is valid when the following conditions are fulfilled:

>>>3: compared to the stored downlink pathloss reference RSRP value, the current RSRP value of the downlink pathloss reference has not increased/decreased by more than inactivePosSRS-RSRP-ChangeThreshold; and

>>>3: TYPE2-I-TAT is running.

>1: UE performs TYPE2-I-SRS transmission in the reselected cell when TA is valid.

>>2: UE performs TYPE2-I-SRS transmission based on the system information of the reselected cell and TYPE1-I-SRS configuration information in RRCRelease message.

>> The cell where system information is received and the cell where RRCRelease message is received can be different.

C-TAT controls how long UE/GNB considers the Serving Cells to be uplink time aligned.

TYPE1-I-TAT controls how long UE/GNB considers TYPE1-I-SRS transmission to be uplink time aligned.

TYPE2-I-TAT controls how long UE/GBN considers TYPE2-I-SRS transmission to be uplink time aligned.

UE manages TATs as below.

At some point of time, UE may need to resume the connection from RRC_INACTIVE to RRC_CONNECTED.

In the context of positioning SRS transmission and I-TAT handling, RRC connection resumption procedure can be performed as below.

Upon initiation of RRC connection resume procedure, UE in cell 1 may:

>1: apply to C-TAT the timeAlignmentTimerCommon included in SIBI of cell 1;

>1: set the contents of RRCResumeRequest:

>>2: set the resumeCause to an appropriate value;

>>2: set the resumeIdentity to the stored full-RNTI;

>1: stop TYPE2-I-TAT and stop (or suspend) TYPE2-I-SRS transmission;

>>2: it is because if TYPE2-I-SRS is transmitted during random access procedure, uplink transmission timing of SRS could be misaligned (when T_TA is set to zero)

>1: perform random access procedure in cell 1:

>>2 determine T_TA for PRACH transmission;

>>>3: by setting N_TA equal to zero and N_TA_offset indicated by n-TimingAdvanceOffset in SIB1 of cell1;

>>2: transmits the PRACH with determined T_TA;

>>2: receive Random Access Response;

>>>3: apply the Timing Advance Command in RAR;

>>>>4: determine T_TA based on:

>>>>>5: the Timing Advance Command; and

>>>>>5: n-TimingAdvanceOffset indicated by SIB1 of cell1;

>>>3: starts C-TAT;

>>2 transmit RRCResumeRequest with the determined T_TA;

>>2: receive Contention Resolution MAC CE;

>>2: restart TYPE2-I-TAT and resume TYPE2-I-SRS transmission;

>1: receive a downlink RRC message response to RRCResumeRequest:

>>2: if the downlink RRC message is either RRCResume or RRCSetup or RRCReject,

>>>3: stop TYPE2-I-TAT and stop TYPE2-I-SRS transmission.

>>2: if the downlink RRC message is RRCRelease,

>>>3: if RRCRelease includes new TYPE2-I-SRS configuration,

>>>>4: restart the TYPE2-I-TAT and start TYPE2-I-SRS transmission based on the new configuration,

>>>3: if RRCRelease does not include new TYPE2-I-SRS configuration,

>>>>4: keep TYPE2-I-TAT running and keep TYPE2-I-SRS transmission.

For C-TAT, UE may:

Start/restart

>1: start or restart C-TAT:

>>2: when a Timing Advance Command MAC CE is received; or

>>2: when Timing Advance Command is received in a Random Access Response message during contention free random access procedure;

stop

>1: stop C-TAT:

>>2: when T300 expires; or

>>2: when T304 expires; or

>>2: when cell selection occurs while T311 is running; or

>>2: when RRCRelease including suspendConfig is received; or

>>2: when RRCReject is received.

For TYPE1-I-TAT, UE may:

>1: start TYPE1-I-TAT upon reception of RRCRelease,

>>2: the RRCRelease includes SuspendConfig;

>>>3: the SuspendConfig includes srs-PosRRC-Inactive;

>1: stop TYPE1-I-TAT:

>>2: when cell reselection occurs toward a cell that is different from the cell where the RRCRelease is received; or

>>2: when a paging is received;

>>>3: the paging message includes UE Identity allocated by upper layer (e.g. NG-5G-S-TMSI) in ue-Identity field; or

>>2: after a RRCResumeRequest is transmitted:

>>>3: if one of RRCResume and RRCSetup and RRCReject is received in response to RRCResumeRequest; or

>>>3: when T319 expires; or

>>>3: when T319a expires; or

>>2: during a RRCResume procedure:

>>>3: cell reselection occurs while T319 or T319a is running; or

>>>3: integrity check failure (e.g. integrity verification failure) for PDCP Data PDU containing RRCResume occurs while T319 or T319a is running; or

>>>3: integrity check failure (e.g. integrity verification failure) for PDCP Data PDU of DRB occurs while T319a is running;

>1: restart TYPE1-I-TAT:

>>2: when a Timing Advance Command MAC CE is received; or

>>2: when Timing Advance Command is received in a Random Access Response message during contention free random access procedure; or

>>2: when the Contention Resolution is considered successful;

>>>3: if C-TAT is not running when Timing Advance Command is received in a Random Access Response message during contention-based andom access procedure.

For TYPE2-I-TAT, UE may:

>1: start TYPE2-I-TAT:

>>2: upon reception of RRCRelease,

>>2: the RRCRelease includes SuspendConfig;

>>>3: the SuspendConfig includes srs_positioning_inactive_multi_cell;or

>>2: upon cell selection after state transition to RRC_INACTIVE from RRC_CONNECTED,

>>>3; the selected cell belongs to SRS-Area; or

>>2: upon cell reselection during RRC_INACTIVE,

>>>3; the selected cell belongs to SRS-Area;

>1: stop TYPE2-I-TAT:

>>2: when cell reselection occurs toward a cell that does not belong to SRS-Area; or

>>2: when a paging is received;

>>>3: the paging message includes UE Identity allocated by upper layer (e.g. NG-5G-S-TMSI) in ue-Identity field; or

>>2: after a RRCResumeRequest is transmitted:

>>>3: if one of RRCResume and RRCSetup and RRCReject is received in response to RRCResumeRequest; or

>>>3: when T319 expires; or

>>>3: when T319a expires; or

>>2: during a RRCResume procedure:

>>>3: cell reselection occurs while T319 or T319a is running;

>>>>4: the reselected cell belongs to SRS-Area; or

>>>>4: the reselected cell does not belong to SRS-Area; or

>>>3: integrity check failure (e.g. integrity verification failure) for PDCP Data PDU containing RRCResume occurs while T319 or T319a is running; or

>>>3: integrity check failure (e.g. integrity verification failure) for PDCP Data PDU of DRB occurs while T319a is running;

>1: restart TYPE2-I-TAT:

>>2: when a Timing Advance Command MAC CE is received; or

>>2: when Timing Advance Command is received in a Random Access Response message during contention free random access procedure; or

>>2: when the Contention Resolution is considered successful;

>>>3: if C-TAT is not running when Timing Advance Command is received in a Random Access Response message during contention-based andom access procedure.

UE performs followings when a TAT stops.

>1: For C-TAT; UE may:

>>2: stop any uplink transmission except Random Access Preamble and MSGA;

>1: For TYPE1-I-TAT, UE may:

>>2: stop TYPE1-I-SRS transmission;

>>2: release TYPE1-I-SRS resources;

>>2: keep configuration information of TYPE1-I-SRS (e.g. srs-PosRRC-Inactive);

>1: For TYPE2-I-TAT, UE may:

>>2: stop TYPE2-I-SRS transmission; and

>>2: keep TYPE2-I-SRS resources; and

>>2: keep configuration information of TYPE2-I-SRS (e.g srs_positioning_inactive_multi_cell);

UE performs followings when a TAT expires.

>1: For C-TAT; UE may:

>>2: stop any uplink transmission except Random Access Preamble and MSGA;

>>2: release PUCCH resource and configuration;

>>2: release C-SRS resource and configuration;

>>2: maintain N_TA;

>1: For TYPE1-I-TAT, UE may:

>>2: stop TYPE1-I-SRS transmission;

>>2: release TYPE1-I-SRS resources;

>>2: release configuration information of TYPE1-I-SRS (e.g. srs-PosRRC-Inactive);

>1: For TYPE2-I-TAT, UE may:

>>2: stop TYPE2-I-SRS transmission; and

>>2: release TYPE2-I-SRS resources; and

>>2: release configuration information of TYPE2-I-SRS (e.g. srs_positioning_inactive_multi_cell); and

>>2: maintain N_TA.

T300 is a timer to supervise RRC connection establishment procedure. T300 starts upon transmission of RRCSetupRequest. T300 stops upon reception of RRCSetup or RRCReject message.

T304 is a timer to supervise handover procedure. T304 starts upon reception of RRCReconfiguration message including reconfiguration WithSync. T304 stops upon successful completion of random access on the corresponding SpCell.

T311 is a timer to supervise RRC connection re-establishment procedure. T311 starts upon initiating the RRC connection re-establishment procedure. T311 stops upon selection of a suitable NR cell.

T319 is a timer to supervise RRC connection resume procedure not initiated for SDT. T319 starts upon transmission of RRCResumeRequest when the resume procedure is not initiated for SDT. T319 stops upon reception of RRCResume.

T319a is a timer to supervise RRC connection resume procedure for SDT. T319a starts upon transmission of RRCResumeRequest when the resume procedure is initiated for SDT. T319a stops upon reception of RRCResume.

The integrity protection includes both integrity protection and integrity verification and is performed in PDCP, if configured. The data unit that is integrity protected is the PDU header and the data part of the PDU before ciphering.

At transmission, the UE computes the value of the MAC-I field and at reception it verifies the integrity of the PDCP Data PDU by calculating the X-MAC based on the input parameters. If the calculated X-MAC corresponds to the received MAC-I, integrity protection is verified successfully. If the calculated X-MAC does not correspond to (e.g. is not equal to) the received MAC-I, the integrity protection is verified unsuccessfully (e.g. integrity check failure occurs).

Terminal may perform followings for SRS transmission in RRC_INACTIVE.

Before performing following operations, UE may receive RRC messages and/or system information in one or more cells.

>1: Terminal determines whether to perform TYPE1-I-SRS transmission or TYPE2-I-SRS transmission based on presence and absence of srs-PosRRC-Inactive and/or srs_positioning_inactive_multi_cell in the RRCRelease;

>>2: if the srs-PosRRC-Inactive is present and srs_positioning_inactive_multi_cell is absent in the RRCRelease,

>>>3: terminal determines to perform TYPE1-I-SRS transmission based on srs-PosRRC-Inactive;

>>2: if the srs-PosRRC-Inactive is absent and srs_positioning_inactive_multi_cell is present in the RRCRelease,

>>>3: terminal determines to perform TYPE2-I-SRS transmission based on srs_positioning_inactive_multi_cell.

>1: srs-PosRRC-Inactive includes SRS configuration information and BWP configuration information and information indicating either normal uplink carrier or supplementary uplink carrier;

>1: srs_positioning_inactive_multi_cell includes SRS-Area information and BWP configuration information and information indicating either normal uplink carrier or supplementary uplink carrier;

>1: In TYPE1-I-SRS transmission operation,

>>2: SRS transmission is performed in a specific cell by a terminal in RRC_INACTIVE;

>1: In TYPE2-I-SRS transmission operation,

>>2: SRS transmission is performed in two or more cells indicated by SRS-Area by a terminal in RRC_INACTIVE.

>1: Terminal in RRC_INACTIVE may perform SRS transmission based on BWP configuration information included in the RRCRelease;

>>2: if SRS-Area information is absent in the RRCRelease.

>>>3: the BWP configuration information is applied to a specific single cell;

>>2: if SRS-Area information is present in the RRCRelease;

>>>3: the BWP configuration information is applied to specific two or more cells;

Usually, RRC_INACTIVE UE may perform uplink transmission in an initial uplink BWP. For better cell resource utilization (and more flexibility in configuring TYPE2-I-SRS resource across multiple cells), UE may perform initial random access procedure and TYPE2-I-SRS transmission in different BWPs.

>1: Terminal in RRC_INACTIVE in a first cell may perform uplink transmission for random access (e.g. for RRC connection resumption or SDT) in a first uplink BWP of the first cell and may perform uplink transmission for SRS in a second uplink BWP of the first cell;

>> the first uplink BWP is determined from a first offsetToCarrier and a first locationAndBandwidth;

>>>3: the first offsetToCarrier is indicated in the system information of the first cell;

>>>3: the first locationAndBandwidth is indicated in the system information of the first cell;

>> the second uplink BWP is determined from a second offsetToCarrier and a second locationAndBandwidth;

>>>3: the second offsetToCarrier is indicated in the system information of the second cell;

>>>3: the first locationAndBandwidth is indicated in a RRC message received in the second cell;

The cellIdentity of the first cell and the cellIdentity of the second cell are different.

>1: Terminal determines the frequency domain portion for SRS transmission in a second cell based on:

>>2: offsetToCarrier (indicating offset between lowest subcarrier of common RB 0 and the lowest usable subcarrier) in system information received in a first cell and locationAndBandwidth (indicating frequency domain location and bandwidth of a BWP) in a RRC message received in the first cell;

>>>3: the RRC message may include information for state transition from RRC_CONNECTED to RRC_INACTIVE;

>>>3: the second cell may be indicated in SRS-Area information in the RRC message.

>1: Terminal in RRC_INACTIVE may perform SRS transmission in a second cell based on:

>>2: offsetToCarrier (indicating offset between lowest subcarrier of common RB 0 and the lowest usable subcarrier) and locationAndBandwidth (indicating frequency domain location and bandwidth of a BWP) in system information of a first cell; and

>>2: n-TimingAdvanceOffset (indicating N_TA offset to be applied for uplink transmission in a serving cell) and p-Max (maximum uplink transmission power of a serving cell) in system information of the second cell

>>2: the first cell is the cell where the RRC message is received >>2: the second cell is indicated in SRS-Area information in the RRC message Terminal performs followings for I-SRS transmission in a first cell.

>1: Terminal in RRC_CONNECTED receives a RRCRelease message in a second cell;

>1: Terminal in RRC_INACTIVE determines whether to perform SRS transmission in a first cell;

>2: if TYPE1-I-SRS is configured and if all conditions of a first condition group are fulfilled;

>>>3: Terminal determines to perform TYPE1-I-SRS transmission in the first cell;

>2: if TYPE1-2-SRS is configured and if all conditions of a second condition group are fulfilled;

>>>3: Terminal determines to perform TYPE2-I-SRS transmission in the first cell;

>1: Terminal performs SRS transmission in the first cell based on the determination;

>1: the first condition group comprises:

>>2: if difference between a first RSRP of a first downlink pathloss reference and a second RSRP of a second downlink pathloss is smaller than a first threshold;

>>2: if both the first downlink pathloss reference and the second downlink pathloss reference are a reference signal of the second cell;

>>2: if the first cell and the second cell are same;

>>2: if TYPE1-I-TAT is running

>1: the second condition group comprises:

>>2: if the first cell belongs to SRS-Area;

>>2: if difference between a third RSRP of a third downlink pathloss reference and a fourth RSRP of a fourth downlink pathloss reference are smaller than a second threshold;

>>2: if both the third downlink pathloss reference and the fourth downlink pathloss reference are a reference signal of the first cell;

>>2: if TYPE2-I-TAT is running;

1>: the first RSRP and the second RSRP are determined at different time points;

1>: the third RSRP and the fourth RSRP are determined at different time points;

For TA validation, terminal performs followings.

>1: Terminal updates the stored RSRP of a downlink pathloss reference at a first time point;

>1: Terminal determines at a second time point whether to perform TYPE2-I-SRS transmission based on consideration on facts including a current RSRP of the downlink pathloss reference and TYPE2-I-TAT if the current RSRP and the stored RSRP are determined based on reference signal of same cell;

>1: Terminal determines at second time point whether to perform TYPE2-I-SRS transmission based on consideration on facts including TYPE2-I-TAT and excluding the current RSRP of the downlink pathloss reference if the current RSRP and the stored RSRP are determined based on reference signal of different cells.

>1: Terminal performs TYPE2-I-SRS transmission based on the determination

For N_TA update after cell reselection, terminal performs followings.

>1: Terminal performs cell reselection from a first cell to a second cell;ss

>1: Terminal update the N_TA based on the time difference between downlink frame boundary of the first cell and downlink frame boundary of the second cell;

>1: Terminal determines the N_TA_offset based on the n-TimingAdvanceOffset received in the first cell;

>1: Terminal determines T_TA based on the determined N_TA_offset and updated N_TA;

>1: Terminal updates the stored RSRP of downlink pathloss reference based on RSRP of reference signal of the second cell;

>1: Terminal performs TYPE2-I-SRS transmission based on the T_TA and pathloss determined from the downlink pathloss reference of the second cell.

For timer handling during RRC resume procedure, UE performs followings.

>1: Terminal receives configuration information for TYPE2-I-SRS in a first cell;

>1: Terminal starts TYPE2-I-TAT;

>1: Terminal performs TYPE2-I-SRS transmission based on the configuration information for TYPE2-I-SRS in the first cell or in a second cell;

>1: Terminal initiates RRC resume procedure in the second cell;

>1: Terminal transmits RRCResumeRequest in the second cell;

>1: Terminal stops TYPE2-I-TAT and transmission of TYPE2-I-SRS if a first DL message is received response to the RRCResumeRequest;

>1: Terminal continues (does not stop) TYPE2-I-TAT and transmission of TYPE2-I-SRS if a second DL message is received response to the RRCResumeRequest;

>1: The first DL message is either RRCResume or RRCSetup or RRCReject;

>1: The second DL message is RRCelease.

For TYPE2-I-TAT handling, terminal performs followings.

>1: Terminal receives configuration information for TYPE2-I-SRS in a first cell;

>1: Terminal starts TYPE2-I-TAT;

>1: Terminal performs TYPE2-I-SRS transmission based on the configuration information for TYPE2-I-SRS in the first cell or in a second cell;

>1: Terminal initiates RRC resume procedure in the second cell;

>1: Terminal transmits RRCResumeRequest in the second cell;

>1: Terminal starts T319;

>1: Terminal determines whether to stop or continue TYPE2-I-TAT based on status of T319;

>>2: TYPE2-I-TAT is considered to expire:

>>>3: if integrity check failure occurs while T319 is running; or

>>>3: if T319 expires;

>>2: TYPE2-I-TAT stops or continue if T319 stops;

>>>3: Terminal stops TYPE2-I-TAT if T319 stops because of reception of a first DL message;

>>>3: Terminal continues TYPE2-I-TAT if 319 stops because of reception of a second DL message;

>1: Terminal, when TYPE2-I-TAT expires:

>>2: stop TYPE2-I-SRS transmission; and

>>2: release TYPE2-I-SRS resource; and

>>2: store (or keep storing) configuration information of TYPE2-I-SRS;

>1: Terminal, when TYPE2-I-TAT stops:

>>2: stop TYPE2-I-SRS transmission; and

>>2: keep TYPE2-I-SRS resource; and

>>2: store (or keep storing) configuration information of TYPE2-I-SRS.

Terminal performs followings for TYPE2-I-TAT handling during random access procedure.

>1: Terminal receives configuration information for TYPE2-I-SRS in a first cell;

>1: Terminal starts TYPE2-I-TAT;

>1: Terminal performs TYPE2-I-SRS transmission in the first cell or in a second cell based on:

>>2: the configuration information for TYPE2-I-SRS; and

>>2: a third N_TA and a second N_TA_offset;

>>>3: the second N_TA_offset is determined based on n-TimingAdvanceOffset received in the first cell

>1: Terminal initiates contention based random access in the second cell;

>1: Terminal performs preamble transmission based on a first N_TA and a first N_TA_offset;

>>2: the first N_TA is a specific value (e.g. 0);

>>2: the first N_TA_offset is determined based on n-TimingAdvanceOffset received in the second cell;

>1: Terminal receives Timing Advance Command response to the preamble;

>1: Terminal updates a second N_TA and starts a C-TAT;

>1: Terminal performs ResumeRequest transmission based on the second N_TA and the first N_TA_offset;

>1: Terminal performs TYPE2-I-SRS transmission based on the third N_TA and the second N_TA_offset;

>1: If Terminal receives a specific downlink MAC CE during a first period;

>>2: Terminal updates the third N_TA such that the third N_TA is equal to the second N_tA; and

>>2: Terminal restarts TYPE2_I_TAT.

The specific downlink MAC CE is UE Contention Resolution Identity MAC CE.

The first period is determined from the time point that is determined based on transmission of ResumeRequest (e.g. MSG3) to the time point that is determined based on ra-ContentionResolutionTimer.

common N_TA for SRS and PUSCH

Terminal performs followings for TYPE2-I-TAT handling during random access procedure.

>1: Terminal receives configuration information for TYPE2-I-SRS in a first cell;

>1: Terminal starts TYPE2-I-TAT;

>1: Terminal performs TYPE2-I-SRS transmission in the first cell or in a second cell based on:

>>2: the configuration information for TYPE2-I-SRS; and

>>2: a third N_TA and a second N_TA_offset;

>>>3: the second N_TA_offset is determined based on n-TimingAdvanceOffset received in the first cell

>1: Terminal initiates contention based random access in the second cell;

>1: Terminal performs preamble transmission based on a first N_TA and a first N_TA_offset;

>>2: the first N_TA is a specific value;

>>2: the first N_TA_offset is determined based on n-TimingAdvanceOffset received in the second cell;

>1: Terminal receives Timing Advance Command response to the preamble;

>1: Terminal updates the third N_TA and starts a C-TAT;

>1: Terminal performs ResumeRequest (e.g. MSG3) transmission based on the third N_TA and the first N_TA_offset;

>1: Terminal performs TYPE2-I-SRS transmission based on the third N_TA and the second N_TA_offset;

>1: If Terminal does not receive a specific downlink MAC CE during a first period (e.g. contention resolution is unsuccessful);

>>2: Terminal set the third N_TA to the value before applying the received Timing Advance Command.

Upon TAC reception, terminal handles TYPE2-I-TAT and N_TA as below.

>1: Terminal receives configuration information for TYPE2-I-SRS in a first cell;

>1: Terminal starts TYPE2-I-TAT;

>1: Terminal performs TYPE2-I-SRS transmission in the first cell or in a second cell based on:

>>2: the configuration information for TYPE2-I-SRS; and

>>2: a third N_TA and a second N_TA_offset;

>>>3: the second N_TA_offset is determined based on n-TimingAdvanceOffset received in the first cell

>1: Terminal receives a Timing Advance Command in the first cell or in the second cell;

>1: If the Timing Advance Command is received in a Timing Advance Command MAC CE; or

>1: If he Timing Advance Command is received in a Random Access Reponse; and the Random Access Preamble was not selected by UE among the contention-based Random Access Preamble (e.g. Timing Advance Command is received in a Random Access Response during contention free random access procedure);

>>2: Terminal apply the Timing Advance Command to the third N_TA and restart TYPE2-I-TAT;

>1: If he Timing Advance Command is received in a Random Access Reponse; and the Random Access Preamble was selected by UE among the contention-based Random Access Preamble (e.g. Timing Advance Command is received in a Random Access Response during contention based random access procedure);

>>2: Terminal apply the Timing Advance Command to the third N_TA upon receiving Timing Advance Command; and terminal start TYPE2-I-TAT when the specific downlink MAC CE is received.

Terminal performs RRC connection resume procedure as below.

>1: Terminal receives RRCRelease including rna-NotificationArea and srs_PosConfig_cell_list;

>1: Terminal performs cell selection or cell reselection towards a second cell;

>1: Terminal receives PBCH and SIB1 in the second cell;

>1: Terminal initiates RRC resume procedure based on the information acquired in the PBCH and the SIB 1 of the second cell;

>1: Terminal sets the resumeCause to rna-Update:

>>2: if the second cell does not belong to RNA and does not belong to SRS-Area; or

>>2: if the second cell does not belong to RNA and belongs to SRS-Area

>1: Terminal sets the resumeCause to srs-area-Update:

>>2: if the second cell belongs to RNA and does not belong to SRS-Area;

>1: Terminal transmits RRCResumeRequest in the second cell with the determined resumeCause.

Terminal performs TYPE2-I-SRS transmission and RRC connection resume procedure as below.

>1: Terminal in a first cell receives a first RRCRelease including rna-NotificationArea and srs_PosConfig_cell_list and srs_PosConfigNUL_multi_cell;

>1: Terminal performs cell selection to a second cell;

>1: Terminal receives PBCH and SIB 1 in the second cell;

>1: Terminal performs TYPE2-I-SRS transmission in normal uplink of the second cell if the second cell belongs to SRS-Area;

>1: Terminal performs cell reselection to a third cell;

>1: Terminal receives PBCH and SIB1 in the third cell;

>1: Terminal stops TYPE2-I-SRS transmission and initiate RRC connection resume procedure in the third cell if the third cell does not belong to SRS-Area;

>1: Terminal sets resumeCause to a first value (rna-upate) if the third cell does not belong to RNA and to a second value (srs-area-update) if the third cell belongs to RNA;

>1: Terminal transmits RRCResumeRequest with the resumeCause;

>1: Terminal in the third cell receives a second RRCRelease.

Terminal determines whether a serving cell belongs to a RNA of the terminal based on one or more PLMN-identity and one or more CellIdentity in SIBI of the serving cell and one or more PLMN-Identity and one or more CellIdentity in ran-NotificationAreaInfo.

Terminal determines that a serving cell does not belong to a RNA:

>1: if none of PLMN-IdentityInfo includes a PLMN-Identity and a CellIdentity that match with a PLMN-Identity and a CellIdentity in any of PLMN-RAN-AreaCell IE of the RNA; or

>1: if none of PLMN-RAN-AreaCell IE of the RNA is indicated by none of a PLMN-identity and a CellIdentity in a PLMN-IdentityInfo of the PLMN-IdentityInfoList.

Terminal determines whether a serving cell belongs to a SRS-Area of the terminal based on one or more CellIdentity in SIBI of the serving cell and one or more CellIdentity in SRS-AreaCell.

Terminal determines that a serving cell does not belong to a SRS-Area:

>1: if none of PLMN-IdentityInfo includes a CellIdentity that match with anya CellIdentity in SRS-AreaCell; or

>1: if none of CellIdentity in SRS-AreaCell is indicated by none of a PLMN-IdentityInfo of the PLMN-IdentityInfoList.

If SRS-AreaCell includes one or more PhysicalCellId, Terminal determines whether a serving cell belongs to a SRS-Area of the terminal based on the PhysicalCellId of the serving cell (acquired from PSS/SSS of the serving cell) and one or more PhysicalCellId in SRS-AreaCell.

Terminal determines that a serving cell does not belong to a SRS-Area:

>1: if PhysicalCellId acquired from PSS/SSS of the serving cell is not indicated in SRS-AreaCell; or

>1: if none of PhysicalCellId in SRS-AreaCell is equal to PhysicalCellId acquired from PSS/SSS of the serving cell.

ResumeCause is used to indicate the resume cause in RRCResumeRequest. ResumeCause IE indicates one of emergency, highPriorityAccess, mt-Access, mo-Signalling, mo-Data, mo-VoiceCall, mo-VideoCall, mo-SMS, rna-Update, mps-Priority Access, mcs-Priority Access and srs-area-Update.

Terminal sets the ResumeCause based on the event that triggered the RRC resume procedure. For example, if a RRC resume procedure is triggered by paging reception, resumeCause is set to mt-Access. If a RRC resume procedure is triggered by uplink data arrival, resumeCause is set to mo-Data.

If more than one event triggers a RRC resume procedure, terminal sets the ResumeCause based on cause_priority. cause_priority of each event is as below. Highest priority is listed first.

Highest cause_priority: Event associated with emergency service (e.g. event associated with ResumeCause emergency;)

Second highest cause_priority: Event associated with paging reception (e.g. event associated with ResumeCause mt-Access);

Third highest cause_priority: Event associated with uplink data arrival (e.g. event associated with ResumeCausemo-Data, highPriority Access etc);

Fourth highest cause_priority: Event associated with RNA change (e.g. event associated with ResumeCause rna-Update)

Lowest cause_priority: Event associated with SRS-Area change (e.g. event associated with ResumeCause srs-area-Update)

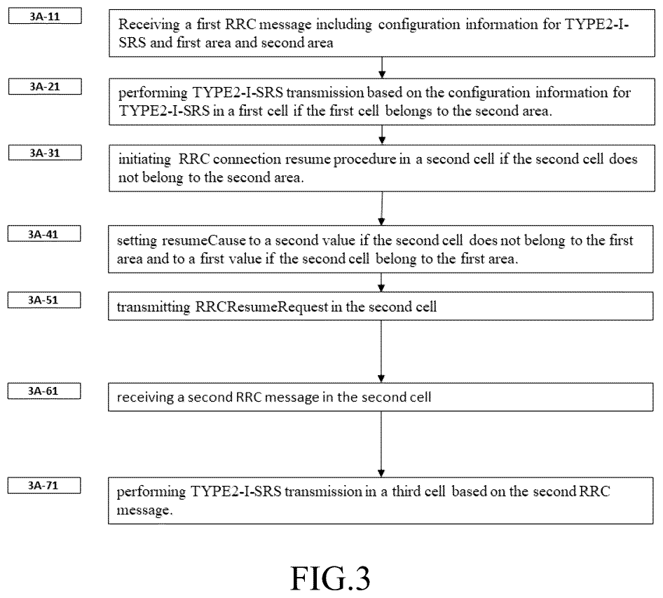

FIG. 3 illustrates operation of terminal.

At 3A-11, UE receives a first RRC message including configuration information for TYPE2-I-SRS and a cell list for a first area and a cell list for a second area.

At 3A-21, UE performs TYPE2-I-SRS transmission based on the configuration information for TYPE2-I-SRS in a first cell if the first cell belongs to the second area.

At 3A-31, UE initiate RRC connection resume procedure in a second cell if the second cell does not belong to the second area.

At 3A-41, UE sets resumeCause to a second value if the second cell does not belong to the first area and to a first value if the second cell belong to the first area.

At 3A-51, UE transmits RRCResumeRequest in the second cell.

At 3A-61, UE receives a second RRC message in the second cell.

At 3A-71, UE performs TYPE2-I-SRS transmission in a third cell based on the second RRC message.

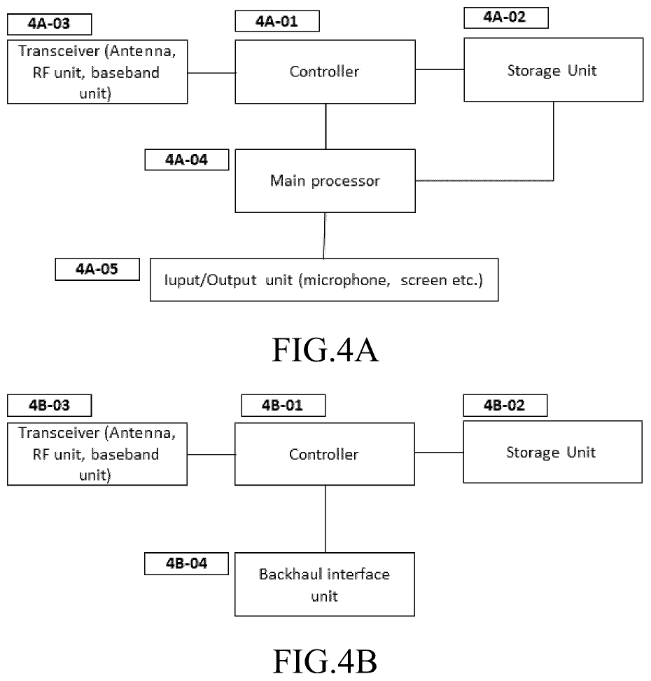

FIG. 4A is a block diagram illustrating the internal structure of a UE to which the disclosure is applied.

Referring to the diagram, the UE includes a controller 4A-01, a storage unit 4A-02, a transceiver 4A-03, a main processor 4A-04 and I/O unit 4A-05.

The controller 4A-01 controls the overall operations of the UE in terms of mobile communication. For example, the controller 4A-01 receives/transmits signals through the transceiver 4A-03. In addition, the controller 4A-01 records and reads data in the storage unit 4A-02. To this end, the controller 4A-01 includes at least one processor. For example, the controller 4A-01 may include a communication processor (CP) that performs control for communication and an application processor (AP) that controls the upper layer, such as an application program. The controller controls storage unit and transceiver such that UE operations illustrated in FIG. 2 and FIG. 3 are performed.

The storage unit 4A-02 stores data for operation of the UE, such as a basic program, an application program, and configuration information. The storage unit 4A-02 provides stored data at a request of the controller 4A-01.

The transceiver 4A-03 consists of a RF processor, a baseband processor and one or more antennas. The RF processor performs functions for transmitting/receiving signals through a wireless channel, such as signal band conversion, amplification, and the like. Specifically, the RF processor up-converts a baseband signal provided from the baseband processor into an RF band signal, transmits the same through an antenna, and down-converts an RF band signal received through the antenna into a baseband signal. The RF processor may include a transmission filter, a reception filter, an amplifier, a mixer, an oscillator, a digital-to-analog converter (DAC), an analog-to-digital converter (ADC), and the like. The RF processor may perform MIMO and may receive multiple layers when performing the MIMO operation. The baseband processor performs a function of conversion between a baseband signal and a bit string according to the physical layer specification of the system. For example, during data transmission, the baseband processor encodes and modulates a transmission bit string, thereby generating complex symbols. In addition, during data reception, the baseband processor demodulates and decodes a baseband signal provided from the RF processor, thereby restoring a reception bit string.

The main processor 4A-04 controls the overall operations other than mobile operation. The main processor 4A-04 process user input received from I/O unit 4A-05, stores data in the storage unit 4A-02, controls the controller 4A-01 for required mobile communication operations and forward user data to I/O unit 4A-05.

I/O unit 4A-05 consists of equipment for inputting user data and for outputting user data such as a microphone and a screen. I/O unit 4A-05 performs inputting and outputting user data based on the main processor's instruction.

FIG. 4B is a block diagram illustrating the configuration of a base station according to the disclosure.

As illustrated in the diagram, the base station includes a controller 4B-01, a storage unit 4B-02, a transceiver 4B-03 and a backhaul interface unit 4B-04.

The controller 4B-01 controls the overall operations of the main base station. For example, the controller 4B-01 receives/transmits signals through the transceiver 4B-03, or through the backhaul interface unit 4B-04. In addition, the controller 4B-01 records and reads data in the storage unit 4B-02. To this end, the controller 4B-01 may include at least one processor. The controller controls transceiver, storage unit and backhaul interface such that base station operation illustrated in FIG. 2 are performed.

The storage unit 4B-02 stores data for operation of the main base station, such as a basic program, an application program, and configuration information. Particularly, the storage unit 4B-02 may store information regarding a bearer allocated to an accessed UE, a measurement result reported from the accessed UE, and the like. In addition, the storage unit 4B-02 may store information serving as a criterion to deter mine whether to provide the UE with multi-connection or to discontinue the same. In addition, the storage unit 4B-02 provides stored data at a request of the controller 4B-01.

The transceiver 4B-03 consists of a RF processor, a baseband processor and one or more antennas. The RF processor performs functions for transmitting/receiving signals through a wireless channel, such as signal band conversion, amplification, and the like. Specifically, the RF processor up-converts a baseband signal provided from the baseband processor into an RF band signal, transmits the same through an antenna, and down-converts an RF band signal received through the antenna into a baseband signal. The RF processor may include a transmission filter, a reception filter, an amplifier, a mixer, an oscillator, a DAC, an ADC, and the like. The RF processor may perform a down link MIMO operation by transmitting at least one layer. The baseband processor performs a function of conversion between a baseband signal and a bit string according to the physical layer specification of the first radio access technology. For example, during data transmission, the baseband processor encodes and modulates a transmission bit string, thereby generating complex symbols. In addition, during data reception, the baseband processor demodulates and decodes a baseband signal provided from the RF processor, thereby restoring a reception bit string.

The backhaul interface unit 4B-04 provides an interface for communicating with other nodes inside the network. The backhaul interface unit 4B-04 converts a bit string transmitted from the base station to another node, for example, another base station or a core network, into a physical signal, and converts a physical signal received from the other node into a bit string. Below table lists acronym used in the present invention.

TABLE 1

| Acronym | Full name | Acronym | Full name |
|---|---|---|---|
| 5GC | 5G Core Network | RACH | Random Access Channel |
| ACK | Acknowledgement | RAN | Radio Access Network |
| AM | Acknowledged Mode | RAR | Random Access Response |
| AMF | Access and Mobility | RA-RNTI | Random Access RNTI |
| | Management Function | RAT | Radio Access Technology |
| ARQ | Automatic Repeat Request | RB | Radio Bearer |
| AS | Access Stratum | RLC | Radio Link Control |
| ASN.1 | Abstract Syntax Notation One | RNA | RAN-based Notification Area |
| BSR | Buffer Status Report | RNAU | RAN-based Notification Area |
| BWP | Bandwidth Part | | Update |
| CA | Carrier Aggregation | RNTI | Radio Network Temporary |
| CAG | Closed Access Group | | Identifier |
| CG | Cell Group | RRC | Radio Resource Control |
| C-RNTI | Cell RNTI | RRM | Radio Resource Management |
| CSI | Channel State Information | RSRP | Reference Signal Received |
| DCI | Downlink Control | | Power |
| | Information | RSRQ | Reference Signal Received |
| DRB | (user) Data Radio Bearer | | Quality |
| DTX | Discontinuous Reception | RSSI | Received Signal Strength |
| HARQ | Hybrid Automatic Repeat | | Indicator |
| | Request | SCell | Secondary Cell |
| IE | Information element | SCS | Subcarrier Spacing |
| LCG | Logical Channel Group | SDAP | Service Data Adaptation |
| MAC | Medium Access Control | | Protocol |
| MIB | Master Information Block | SDU | Service Data Unit |
| NAS | Non-Access Stratum | SFN | System Frame Number |
| NG-RAN | NG Radio Access Network | S-GW | Serving Gateway |
| NR | NR Radio Access | SI | System Information |
| PBR | Prioritised Bit Rate | SIB | System Information Block |
| PCell | Primary Cell | SpCell | Special Cell |
| PCI | Physical Cell Identifier | SRB | Signalling Radio Bearer |
| PDCCH | Physical Downlink Control | SRS | Sounding Reference Signal |
| | Channel | SS | Search Space |
| PDCP | Packet Data Convergence | SSB | SS/PBCH block |
| | Protocol | SSS | Secondary Synchronisation |
| PDSCH | Physical Downlink Shared | | Signal |
| | Channel | SUL | Supplementary Uplink |
| PDU | Protocol Data Unit | TM | Transparent Mode |
| PHR | Power Headroom Report | UCI | Uplink Control Information |
| PLMN | Public Land Mobile Network | UE | User Equipment |
| PRACH | Physical Random Access | UM | Unacknowledged Mode |
| | Channel | CRP | Cell Reselection Priority |
| PRB | Physical Resource Block | FPP | First positioning protocol |
| PSS | Primary Synchronisation | SPP | Second positioning protocol |
| | Signal | DL-PRS | Downlink-Positioning |
| PUCCH | Physical Uplink Control | | Reference Signal |
| | Channel | SL-PRS | Sidelink-Positioning |
| PUSCH | Physical Uplink Shared | | Reference Signal |
| | Channel | | |
| DL-AoD | Downlink Angle-of- | | |
| | Departure | | |
| GNSS | Global Navigation Satellite | | |
| | System | | |

What is claimed is:

1. A method by a terminal, the method comprising:
receiving by the terminal a specific radio resource control (RRC) message, wherein the specific RRC message comprises:
a first list of cell identities, wherein the first list is related to notification area;
a second list of cell identities, wherein the second list is related to sounding reference signal (SRS) transmission in RRC inactive state; and
a set of SRS configuration parameters;
performing by the terminal a SRS transmission based on the set of SRS configuration parameters;
performing by the terminal cell reselection to a first cell; and
performing by the terminal a specific set of operations in case that a cell identity of the first cell does not belong to the second list,
wherein the specific set of operations comprises:
stopping the SRS transmission; and
transmitting a RRC message for resume request,
wherein the RRC message for resume request comprise a cause field set to a specific value related to notification area in case that the cell identity of the first cell belongs neither to the first list nor to the second list, and
wherein the RRC message for resume request comprise the cause field set to a specific value related to SRS in case that the cell identity of the first cell belongs to the first list and not to the second list.

2. The method of claim 1, wherein:
the cell identity comprises a first part and a second part:
the first part corresponds to an identifier of a base station; and
the second part corresponds to an identifier of a cell, which is unique among identifiers of cells associated with the base station.

3. The method of claim 1,
wherein the terminal determines that the cell identity of the first cell does not belong to the first list based on:
one or more public land mobile network identities comprised in a system information of the first cell;
one or more cell identities comprised in the system information of the first cell; and
one or more cell identities comprised in the first list.

4. The method of claim 1,
wherein the terminal determines that the cell identity of the first cell does not belong to the second list based on:
one or more public land mobile network identities comprised in a system information of the first cell;
one or more cell identities comprised in the system information of the first cell; and
one or more cell identities comprised in the second list.

5. The method of claim 1, the method further comprising:
receiving by the terminal a RRC message for resume in response to the RRC message for resume request.

6. The method of claim 5,
wherein the terminal performs integrity check of the RRC message for resume based on a message authentication code associated with the RRC message for resume.

7. The method of claim 6,
wherein a time alignment timer expires in case that the integrity check of the RRC message for resume fails.

8. The method of claim 7, wherein, upon expiry of the time alignment timer, the terminal:
releases the set of SRS configuration parameters in case that SRS resource associated with the set of SRS configuration parameter is a first type resource; and
does not release the set of SRS configuration parameters in case that SRS resource associated with the set of SRS configuration parameter is a second type resource.

9. The method of claim 8, wherein:
the first type resource is configured in a single cell; and
the second type resource is configured in two or more cells.

10. A terminal comprising:
a transceiver,
a memory, and
a controller coupled to the transceiver and the memory, wherein the controller is configured to cause the terminal to:
receive a specific radio resource control (RRC) message, wherein the specific RRC message comprises:
a first list of cell identities, wherein the first list is related to notification area;
a second list of cell identities, wherein the second list is related to sounding reference signal (SRS) transmission in RRC inactive state; and
a set of SRS configuration parameters;
perform a SRS transmission based on the set of SRS configuration parameters;
perform cell reselection to a first cell; and
perform a specific set of operations in case that a cell identity of the first cell does not belong to the second list,
wherein the specific set of operations comprises:
stopping the SRS transmission; and
transmitting a RRC message for resume request,
wherein the RRC message for resume request comprise a cause field set to a specific value related to notification area in case that the cell identity of the first cell belongs neither to the first list nor to the second list, and
wherein the RRC message for resume request comprise the cause field set to a specific value related to SRS in case that the cell identity of the first cell belongs to the first list and not to the second list.
